(19) United States
(12) Patent Application Publication
(10) Pub. No.: US 2021/0380895 A1
(43) Pub. Date: Dec. 9, 2021

(54) Compositions for Use in Internal-Combustion Engines and Methods of Forming and Using Such Compositions

(71) Applicant: Sylvatex, Inc., Sunnyvale, CA (US)

(72) Inventors: Virginia M. Klausmeier, San Francisco, CA (US); Kristen L. Aramthanapon, Urbana, IL (US)

(21) Appl. No.: 17/347,082

(22) Filed: Jun. 14, 2021

Related U.S. Application Data
(63) Continuation of application No. 15/588,539, filed on May 5, 2017.
Application No. 15/588,539 is a continuation-in-part of application No. 15/153,623, filed on May 12, 2016, now abandoned.
Application No. 15/153,623 is a continuation of application No. 14/216,810, filed on Mar. 17, 2014, now abandoned.
Application No. 14/216,810 is a continuation of application No. 13/966,207, filed on Aug. 13, 2013, now abandoned.
Application No. 13/966,207 is a continuation-in-part of application No. 13/217,171, filed on Aug. 24, 2011, now abandoned.
Application No. 13/217,171 is a continuation of application No. 12/105,164, filed on Apr. 17, 2008, now abandoned.
(60) Provisional application No. 62/332,435, filed on May 5, 2016.
(60) Provisional application No. 61/798,461, filed on Mar. 15, 2013.
(60) Provisional application No. 61/798,438, filed on Mar. 15, 2013.
(60) Provisional application No. 60/974,779, filed on Sep. 24, 2007.
(60) Provisional application No. 61/036,007, filed on Mar. 12, 2008.

(51) Int. Cl. C10L 1/32; C10L 10/12; C10L 1/10; C10L 1/02

(52) U.S. Cl. CPC C10L 1/328; C10L 10/12; C10L 1/1266; C10L 1/026; C10L 1/10

(57) ABSTRACT

A fuel composition for use in internal-combustion engines has a fuel component, an alcohol component, a water component, a microemulsion blend, and a cetane-enhancer component. The microemulsion blend includes at least one of lower grade fatty acid derivatives being present in an amount effective for the fuel, alcohol, and water components to form a microemulsion blend. The emulsifier is present in an amount effective for the biodiesel fuel, alcohol, water, and emulsifier to form an emulsion.

### CROSS-REFERENCES TO RELATED APPLICATIONS

This application claims the benefit under 35 U.S.C. § 119(e) of U.S. Provisional Patent Application Ser. No. 62/332,435, filed May 5, 2016 and is also a continuation-in-part of U.S. patent application Ser. No. 15/153,623, filed May 12, 2016, each of which is hereby incorporated by reference in its entirely for all purposes.

U.S. patent application Ser. No. 15/153,623 is a continuation of U.S. patent application Ser. No. 14/216,810, filed Mar. 17, 2014 and entitled COMPOSITIONS FOR USE IN INTERNAL-COMBUSTION ENGINES AND METHODS OF FORMING AND USING SUCH COMPOSITIONS, which application claims the benefit under 35 U.S.C. § 119(e) of U.S. Provisional Patent Application, Ser. Nos. 61/798,461 and 61/798,438, each filed Mar. 15, 2013, and each of which is hereby incorporated by reference in its entirety for all purposes.

U.S. patent application Ser. No. 14/216,810 is a continuation of U.S. patent application Ser. No. 13/966,207, filed Aug. 13, 2013 and entitled METHOD OF FORMULATING A FUEL COMPOSITION FOR USE IN INTERNAL-COMBUSTION ENGINES, which application is a continuation-in-part of U.S. patent application Ser. No. 13/217,171, filed Aug. 24, 2011 and entitled METHOD OF FORMULATING A FUEL COMPOSITION FOR USE IN INTERNAL-COMBUSTION ENGINES, which application is a continuation of U.S. patent application Ser. No. 12/105,164, filed Apr. 17, 2008 and entitled METHOD OF FORMULATING A FUEL COMPOSITION FOR USE IN INTERNAL-COMBUSTION ENGINES, which application claims priority to U.S. Provisional Patent Application Ser. No. 60/974,779, filed Sep. 24, 2007 and entitled MICROEMULSION FUEL COMPOSITIONS AND METHODS FOR PRODUCING THE SAME and also claims priority to U.S. Provisional Patent Application Ser. No. 61/036,007, filed Mar. 12, 2008 and entitled FUEL COMPOSITIONS FOR USE IN INTERNAL-COMBUSTION ENGINES AND METHODS OF FORMING USING SUCH COMPOSITIONS, each of which is incorporated herein by reference in its entirety for all purposes.

### TECHNICAL FIELD

The disclosure relates to the field of fuel compositions. More particularly, the disclosure relates to fuel compositions and fuel additives for internal combustion engines.

### BRIEF DESCRIPTION OF THE DRAWINGS

FIG. 1 is a schematic block diagram showing a new method for synthesizing and formulating a fuel composition for use in internal-combustion engines in accordance with the present invention.

FIGS. 2A-2C show a method and apparatus for formulating a fuel composition on large scale in accordance with the present invention.

FIGS. 3A-3B illustrate a blending apparatus for blending fuel and microemulsion blend for formulating fuel composition in accordance with the present invention.

FIG. 4 show a storage container for storing a fuel composition made in accordance with the present invention.

### DETAILED DESCRIPTION OF THE INVENTION

The invention provides fuel compositions for use in internal-combustion engines, and methods of forming and using such compositions.

The fuel compositions generally comprise (1) a hydrocarbon fuel, such as diesel, (2) a polar fluid, such as alcohol, water, and/or other oxygen rich fluids, (3) an emulsifier present in an amount effective for the hydrocarbon fuel, polar fluid, and emulsifier to form an emulsion; and (4) a cetane enhancer, such as 2-ethylhexyl nitrate. The emulsifier may be selected from a group consisting of noncyclic polyol fatty acid esters and noncyclic polyol fatty alcohol ethers. In some embodiments, at least about half of the emulsifier is selected from this group. In other embodiments, at least about half of this group is mono-substituted. The emulsifier also may consist essentially of a single molecular species having both polar and nonpolar portions.

The methods generally comprise methods of forming and using the fuel compositions, including components thereof. For example, the invention provides methods of forming the emulsifier, by synthesizing and/or purifying components of the emulsifier. These components may include noncyclic polyol fatty acid esters and noncyclic polyol fatty alcohol ethers.

These and other aspects of the invention are described in the following four sections: (1) synthesis of noncyclic polyol fatty acid esters and noncyclic polyol fatty alcohol ethers, (2) purification of noncyclic polyol fatty acid esters and noncyclic polyol fatty alcohol ethers, (3) fuel compositions, and (4) examples.

Monoglycerides of fatty acids have been used for years as surfactants in a variety of food, cosmetic, and other formulated products. In most applications, industrial-grade monoglyceride compositions having 40-55% monoglyceride content have proven suitable. However, the present application in fuel formulations requires high-purity monoglycerides to yield optimal performance, and inexpensive monoglycerides to be economically practical.

Monoglycerides have been synthesized by a variety of methods. Unfortunately, these methods generally yield products that must be further distilled or extracted to obtain high-purity monoglycerides. Moreover, these methods generally are unsuitable for forming monoglycerides of unsaturated fatty acids, such as oleic acid, because of oxidative decomposition at the point of unsaturation. U.S. Pat. No. 2,022,493 to Christensen et al. discloses the conventional method for synthesizing monoglycerides, which involves the transesterification of triglycerides with glycerol and sodium hydroxide to form the monoglycerides. However, the product of this method is a mixture of 40-55% monoglyceride, 20-30% diglyceride, and a remainder of unreacted triglyceride. U.S. Pat. No. 2,132,437 to Richardson et al. and U.S. Pat. No. 2,073,797 to Hilditch et al. disclose two methods of increasing monoglyceride selectivity by converting the triglyceride to free fatty acid before esterification. However, the products of these methods are still contaminated with at least 20% di- and triglyceride, and the methods are considerably more complex than the conventional method. U.S. Pat. No. 5,153,126 to Schroder et al. discloses a method for making additional gains in selectivity by using a lipase enzyme as the transesterification catalyst. However, this method is very costly and difficult to scale up.

A fuel composition for use in internal-combustion engines has a fuel component, an alcohol component, a water component, a microemulsion blend, and a cetane-enhancer component. The microemulsion blend includes at least one of lower grade fatty acid derivatives being present in an amount effective for the fuel, alcohol, and water components to form a microemulsion blend. The emulsifier is present in an amount effective for the biodiesel fuel, alcohol, water, and emulsifier to form an emulsion.

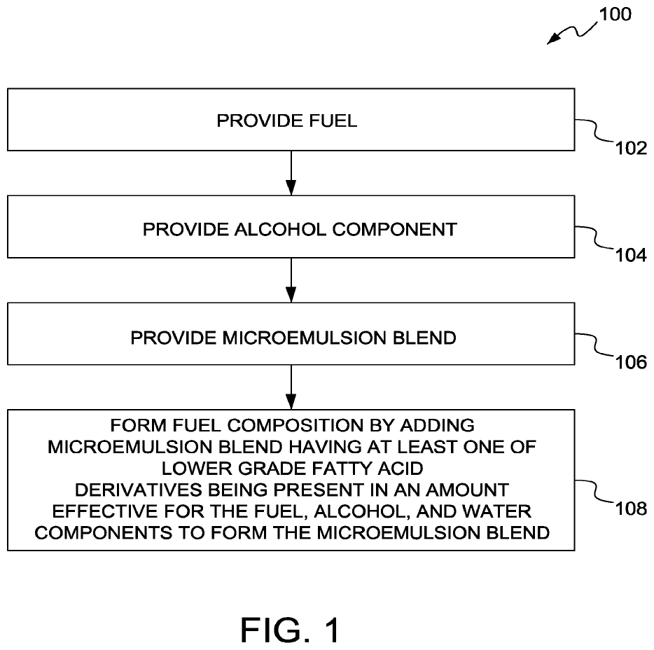

FIG. 1 shows a new method 100 for synthesizing and formulating a fuel composition for use in internal-combustion engines. At step 102 a fuel is provided, the fuel is non-renewable content in the fuel composition. The fuel can be diesel. A non-renewable content is selected. The non-renewable content may include lower grade fatty acid derivatives (or surfactant) and/or other surfactants. At step 104, an alcohol component such as, but not limited to, lower grade ethanol (i.e. hydrous ethanol, and so forth) may be provided. Then at step 106, a microemulsion blend having at least one of lower grade fatty acid derivatives is provided. The steps 102 to steps 106 can be performed in any order. The microemulsion blend is considered to be extremely fine colloidal dispersions consisting of micelles, or “bubbles,” of water and alcohol coated with a layer of surfactant.

Thereafter, at step 108, the fuel composition is formed or formulated by adding to the fuel and the microemulsion blend having at least one of lower grade fatty acid derivatives being present in an amount effective for the fuel, alcohol, and water components to form the microemulsion blend. The blend may include a mixture of oleic acid, ethanol, ammonia, water, and cetane enhancer.

These steps may be performed under conditions that would tend not to substantially reduce an unsaturated fatty acid or fatty chloride. Such conditions may include performing one or more of the steps in an inert atmosphere, such as a nitrogen atmosphere, or performing one or more of the steps in the absence of light.

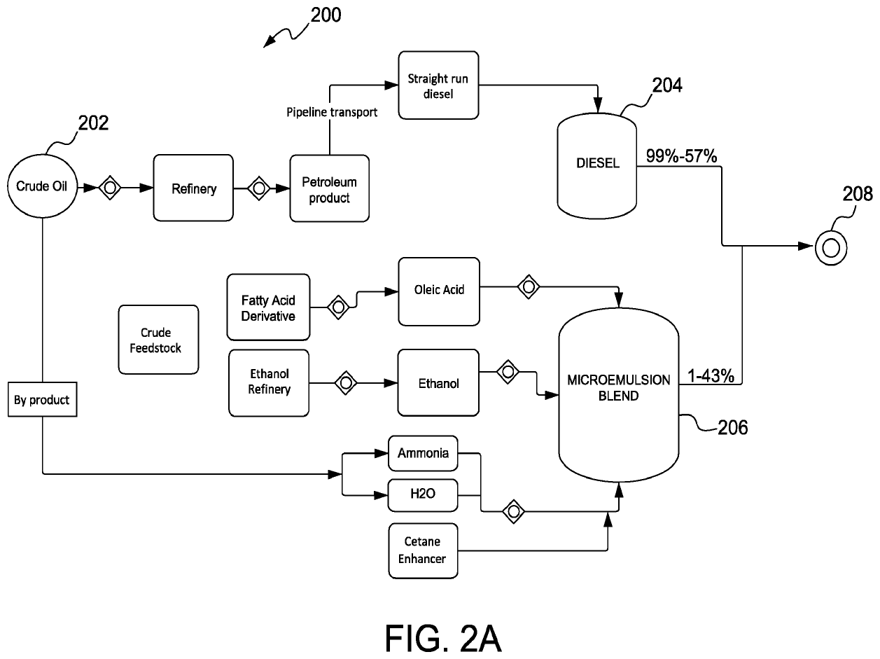

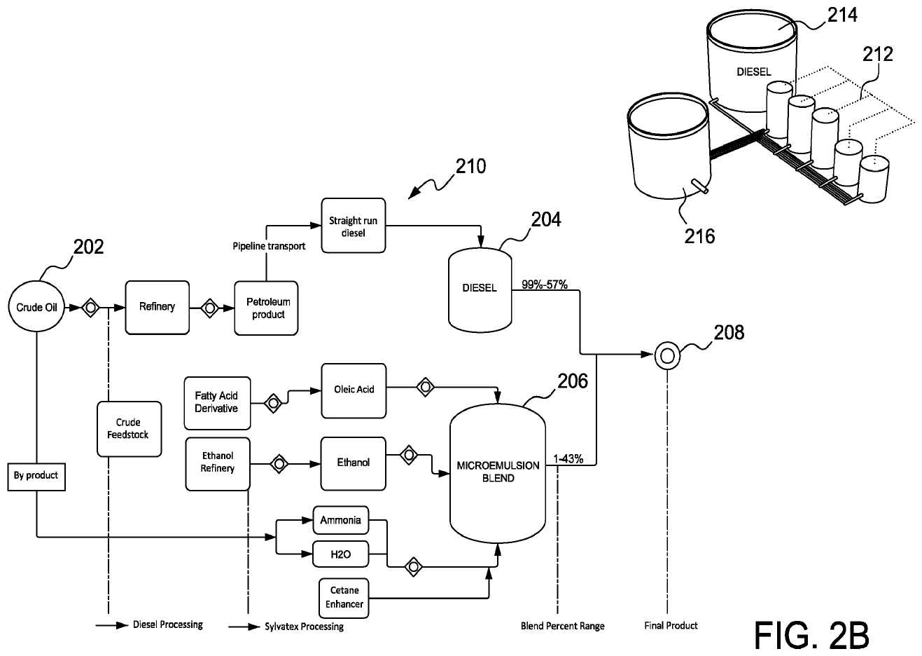

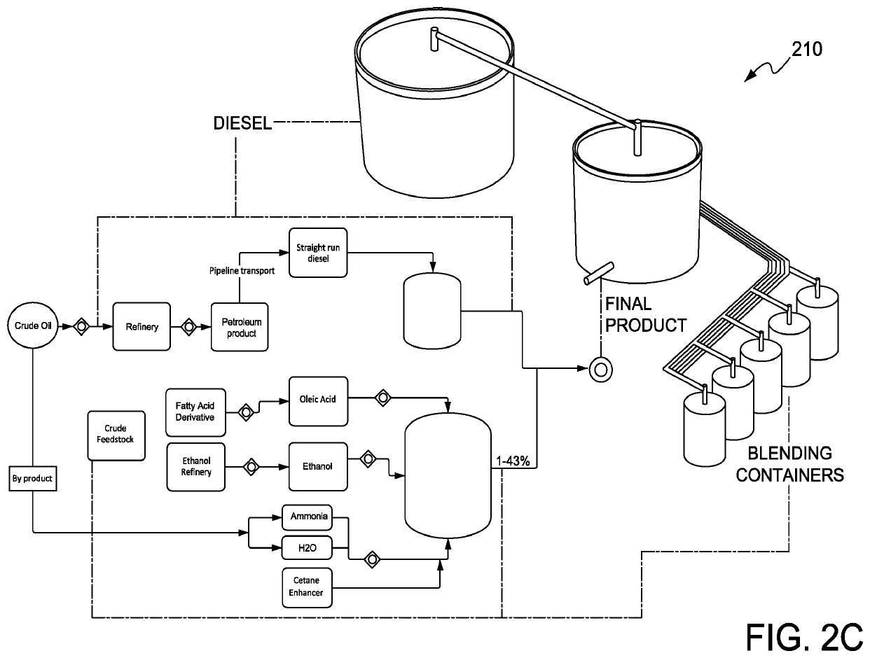

FIG. 2A shows a method 200 for formulating a fuel composition on large scale. The method 200 may include refining crude oil 202 and through one or more refining process fuel is derived. The fuel can be straight run diesel 204. Similarly, lower grade fatty acid derivatives, such as, oleic acid, ethanol, and bi products of crude oil such as ammonia, water, along with cetane enhancer are blended to form microemulsion blend 206. The microemulsion blend 206 may include at least one of lower grade fatty acid derivatives that may be present in an amount effective for the fuel 204, alcohol, and water components to form a microemulsion blend 206. The fatty acid can be oleic acid. Then, at least 57 to 99% of fuel 204 i.e. diesel can be blended with 43-1% of microemulsion blend 206 to formulate a fuel composition 208. The method 200 may also include assessing the quality of the microemulsion blend 206 that can be done by analyzing at least one of an oxidative stability and contaminates in the microemulsion blend 206.

FIG. 2B depicts an apparatus 210 for formulating fuel composition. The apparatus 210 may include a first container 214 and a second container 216 for storing diesel/fuel 204 and microemulsion blend 206 respectively. The straight run diesel 204 may be stored in the first container 214. The diesel 204 and the microemulsion blend 206 may be fed into the first and second containers 214-216 respectively. The first container 214 and the second container 216 may be connected to one or more blending containers 212A-N through one or more pipelines 218A-N. And the diesel 204 can be a straight run diesel or an unadditized diesel. The content of first and second containers 214-216 may be supplied through the connecting pipelines 218A-N to one or more blending containers 212A-N. In the blending containers 212A-N, the microemulsion blend 206 may be blended with fuel, water, ammonia, cetane enhancer, and alcohol to form the fuel composition 208 (final product). The microemulsion blend 206 may be blended in different volumes with the fuel 204 (or diesel) which can be 5%, 6%, 12%, and so forth.

The microemulsion blend 206 can be blended with lower grade diesel or fuel 204 by using inline blending process at a petroleum terminal. The inline blending process includes blending of the microemulsion blend 206 at the petroleum terminal(s) within one or more pipelines. Alternatively, the microemulsion blend 206 can be blended with lower grade diesel/fuel 204 by performing splash blending at the petroleum terminal. The splash blending may include blending the microemulsion blend 206 in a storage container (See 702 in FIG. 7) and then blending with the diesel 204 in distribution vehicle to splash blend in a transportation tank (not shown). The microemulsion blend may also be blended with the fuel by performing splash blending at a distributor by blending microemulsion blend 206 when blending the diesel (or fuel) 204 to have the fuel composition 208 for distribution.

FIG. 2C illustrates another view of the apparatus 210 for formulating fuel composition at large scale.

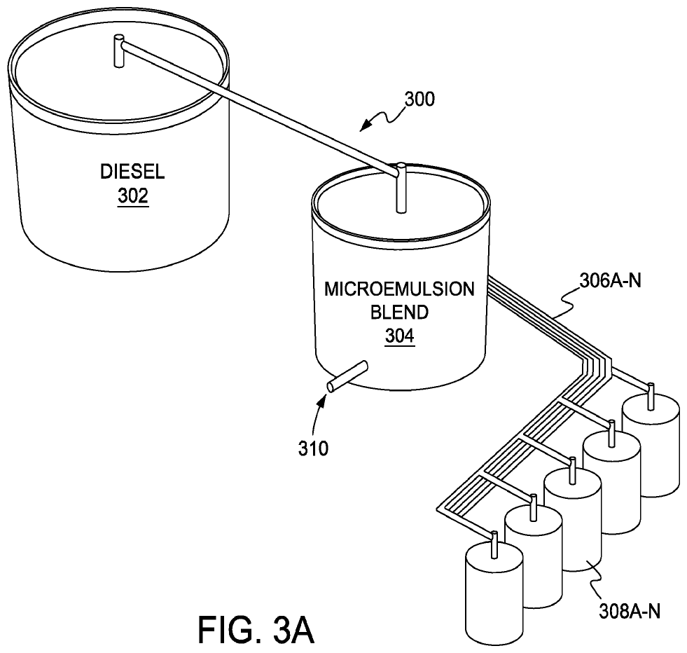

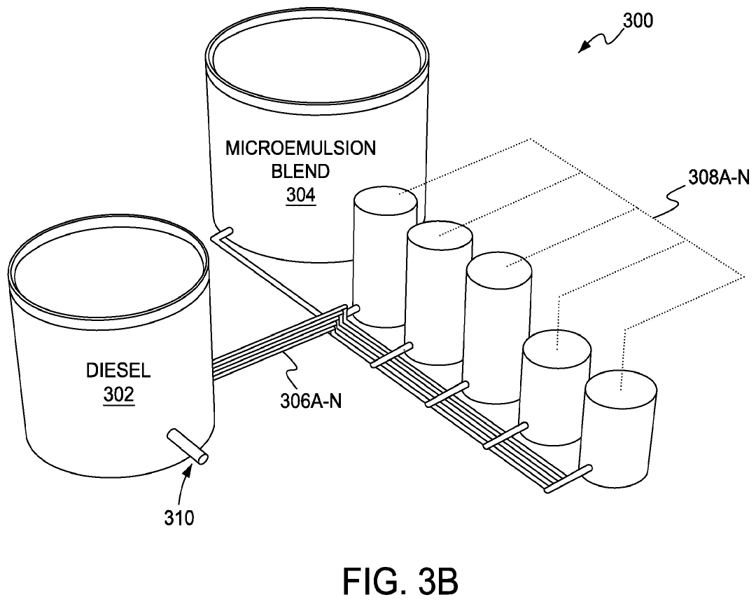

FIGS. 3A-3B illustrate a blending apparatus 300 for blending fuel and microemulsion blend for formulating fuel composition. The microemulsion blend comprises a mixture of oleic acid, ethanol, ammonia, water, and cetane enhancer. The fuel can be diesel which is at least one of a straight run diesel or an unadditized diesel. As shown in FIG. 3A, the blending apparatus 300 may include a first container 302 for storing fuel and a second container 304 for storing microemulsion blend. The second container 304 may include an inlet/outlet pipeline 310. Similarly, the first container 302 may include an inlet/outlet pipeline 312 as shown in FIG. 3B. The first and second containers 302-304 may be connected to one or more blending containers 308A-N through a number of pipelines 306A-N. The microemulsion blend volumes which are blended with the lower grade diesel component can be such as, but not limited to, 5%, 6%, and 12%. The microemulsion blend may be blended with the lower grade fuel by performing processes such as, but not limited to, inline blending at a petroleum terminal, splash blending at the petroleum terminal, and splash blending at a distributor.

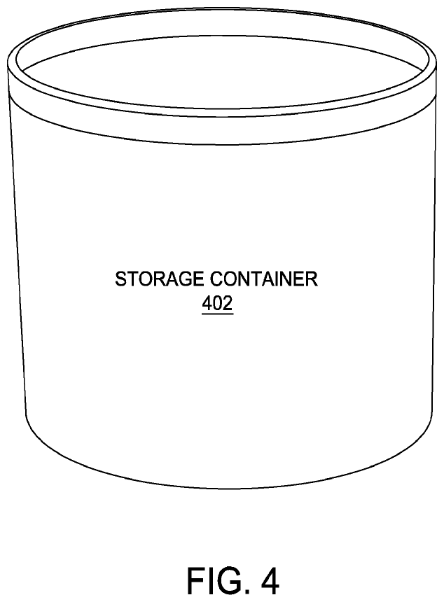

FIG. 4 shows a storage container 402 for storing the fuel composition formed by blending the fuel, an alcohol, water, a cetane emulsifier, and microemulsion blend.

The invention is also described further in the Appendix to the Specification.

In the preceding description, various aspects of claimed subject matter have been described. For purposes of explanation, specific numbers, systems and/or configurations were set forth to provide a thorough understanding of the claimed subject matter. However, it should be apparent to one skilled in the art having the benefit of this disclosure that claimed subject matter may be practiced without the specific details. In other instances, features that would be understood by one of ordinary skill were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

We claim:

1. A fuel composition for use in internal-combustion engines, the fuel composition comprising:
a fuel component;
an alcohol component;
a water component
a microemulsion blend comprising at least one of lower grade fatty acid derivatives being present in an amount effective for the fuel, alcohol, and water components to form a microemulsion blend; and
a cetane-enhancer component.

2. The fuel composition of claim 1, wherein the alcohol component is selected from a group of a lower grade ethanol or hydrous ethanol.

3. The fuel composition of claim 2, wherein the microemulsion blend is blended with lower grade diesel to form the fuel composition.

4. The fuel composition of claim 3, wherein the fuel is diesel which is at least one of a straight run diesel or an unadditized diesel.

5. The fuel composition of claim 4, wherein the microemulsion blend volumes which are blended with the lower grade diesel component is at least one of 5%, 6%, and 12%.

6. The fuel composition of claim 5, wherein the microemulsion blend comprises renewable components.

7. The fuel composition of claim 6, wherein the microemulsion blend comprises a mixture of oleic acid, ethanol, ammonia, water, and a cetane enhancer.

8. A method of formulating a fuel composition for use in internal-combustion engines, the method comprising:
providing a fuel; and
forming the fuel composition by adding to the fuel, a microemulsion blend comprising at least one of lower grade fatty acid derivatives being present in an amount effective for the fuel, alcohol, and water components to form the microemulsion blend, wherein the microemulsion blend includes mixture of oleic acid, ethanol, ammonia, water and cetane enhancer.

9. The method of claim 8 further comprising blending the microemulsion blend with lower grade diesel by performing at least one of the following processes:
inline blending at a petroleum terminal, the inline blending comprises blending of the microemulsion blend at the petroleum terminals within one or more pipelines;
splash blending at the petroleum terminal, the splash blending comprises blending the microemulsion blend in storage container and then blending with the diesel component in distribution vehicle to splash blend in a transportation tank; and
splash blending at a distributor by blending microemulsion blend with the diesel component to have the fuel composition for distribution.

10. The method of claim 8 further comprising assessing the quality of the microemulsion blend.

11. The method of claim 10, wherein the quality is assessed by analyzing at least one of an oxidative stability and contaminates in the microemulsion blend.

12. The method of claim 11 further comprising optimizing the microemulsion blend volumes to be blended with different quality of the diesel.

13. The method of claim 12, wherein alcohol component comprises at least one of an ethanol, or hydrous ethanol.

14. The method of claim 13, wherein the diesel is at least one of a straight run diesel or an unadditized diesel.

15. The method of claim 14, wherein the microemulsion blend volumes which are blended with the lower grade diesel component is at least one of 5%, 6%, and 12%.

16. The method of claim 15, wherein the microemulsion blend comprises renewable components.
